(19) United States
(12) Patent Application Publication
(10) Pub. No.: US 2011/0021953 A1
(43) Pub. Date: Jan. 27, 2011

(54) PASSIVE EXERCISE APPARATUS

(75) Inventors: Wataru Sanematsu, Hirakata-shi (JP); Nozomu Tohyama, Neyagawa-shi (JP); Masamichi Miyaguchi, Hikone-shi (JP); Bungo Imai, Hirakata-shi (JP)

Correspondence Address: EDWARDS ANGELL PALMER & DODGE LLP, P.O. BOX 55874, BOSTON, MA, 02205, US

(73) Assignee: Panasonic Electric Works Co., Ltd., Osaka (JP)

(21) Appl. No.: 12/736,300

(22) PCT Filed: Mar. 31, 2008
(86) PCT No.: PCT/JP2008/056432

§ 371 Date: Sep. 28, 2010

(51) Int. Cl. A61H 1/00

(52) U.S. Cl. 601/5

(57) ABSTRACT

Exercise apparatus is configured to cause a human body to exercise by adding an external force generated through a drive means to the human body to cause the human body to exert a force counteracting the external force. The apparatus includes: a timer means 21 for measuring the time, which the drive means operated, as exercise time; a storage means 6 for storing the measured exercise time together with time and date; and an arithmetic control means 2 for indicating accumulated exercise time evaluated from the stored exercise time to a user through an indication means 4. The continuity of exercise can be enhanced and the calculated exercise can be easily practiced.

### TECHNICAL FIELD

The invention relates generally to exercise apparatus and, more particularly, to passive exercise apparatus.

### BACKGROUND ART

There is passive exercise apparatus that is configured to cause a person to excise by adding an external force generated by a drive means to the human body so that the person exerts a force counteracting the external force. Japanese Patent Application Publication No. 2001-286578 is known as this type of apparatus, and provides the exercise simulating horse riding.

In the exercise obtained by using the apparatus, the continuity is highly important, and it is preferable that exercise is performed for certain time every day. However, some users often fail to continue exercising by their temporal convenience, physical condition or the like. Even if they set their targets to try to exercise according to the targets, they may not carry out the targets.

### DISCLOSURE OF THE INVENTION

The present invention is provided in view of these respects described above, and an object is to provide exercise apparatus capable of enhancement of continuity of exercise and easy practice of calculated exercise.

In order to solve the problem, exercise apparatus of the present invention is configured to cause a human body to exercise by adding an external force generated through a drive means to the human body to cause the human body to exert a force counteracting the external force. In an aspect of the invention, the apparatus includes: a timer means for measuring the time that the drive means operated, said time being measured as exercise time; a storage means for storing the measured exercise time together with time and date; and an arithmetic control means for indicating accumulated exercise time evaluated from the stored exercise time to a user through an indication means. The time in which exercise was performed so far is indicated, and accordingly the user can easily enhance the motivation to exercise on target for increasing the accumulated exercise time, and make a plan of effective exercise.

In case the indication means is a display, the arithmetic control means may be configured to display days, on each of which exercise was performed, in a calendar format on the display.

It is preferable that the apparatus comprise an input part for entering a desired attainment target exercise amount and a target date to be attained with respect to the target exercise amount, and the arithmetic control means is configured: to evaluate a target exercise amount per day by dividing an exercise amount difference by the number of days from the present time and date to the target date, said exercise amount difference being a difference between an accumulated exercise amount obtained from the accumulated exercise time and the attainment target exercise amount; and to indicate the target exercise amount to the user through the indication means.

In this instance, preferably, the arithmetic control means is configured to further perform the drive control of the drive means, and continuously drive the drive means only during the exercise time that the target exercise amount is obtained.

The apparatus may comprise a content storage means for storing content. The arithmetic control means may be configured: to evaluate a provisional exercise consumption by multiplying an exercise amount by the number of days from an exercise start date to the present time and date, said exercise amount being obtained by dividing the attainment target exercise amount by the number of days from the exercise start date to the target date; and to execute the content when the provisional exercise consumption substantially equals the accumulated exercise amount. In this instance, if the content can be executed by the day based on the number of the days from the start date to the target date, the arithmetic control means may be configured to execute a part of the content, said part being a part from the start date to the present time and date.

### EFFECT OF THE INVENTION

In the present invention, whenever exercise is performed by using the exercise apparatus, the exercise time is measured and stored, and accumulated exercise time is indicated to a user. The user can clearly understand how much exercise was performed by using the exercise apparatus. In addition, the user can make a goal for increasing the accumulated exercise time to exercise. The motivation to practice of exercise and continuity of exercise can be easily enhanced and a plan of effective exercise can be made.

If days, one each of which exercise was performed, are displayed in a calendar format on the display, the user can clearly understand the days that exercise was performed and the days that exercise was not performed, so far. The user can easily grasp the user's exercise history and can also easily make the next plan of exercise.

The user can easily understand how much exercise is required per day in order to perform the exercise of the attainment target exercise amount by the target date, in case the apparatus includes an input part for entering an desired attainment target exercise amount and a target date to be attained with respect to the target exercise amount, and the arithmetic control means is configured: to evaluate a target exercise amount per day by dividing an exercise amount difference by the number of days from the present time and date to the target date, said exercise amount difference being a difference between an accumulated exercise amount obtained from the accumulated exercise time and the attainment target exercise amount; and to indicate the target exercise amount to the user through the indication means.

In this instance, if the arithmetic control means continuously drives the drive means only during the exercise time in which the target exercise amount is obtained, it is possible to surely attain the target exercise amount of the day.

The user can enjoy the content executed when exercising smoothly according to the plan and easily enhance the motivation to exercise every day, in case the arithmetic control means evaluates a provisional exercise consumption by multiplying an exercise amount by the number of days from an exercise start date to the present time and date, said exercise amount being obtained by dividing the attainment target exercise amount by the number of days from the exercise start date to the target date; and to execute the content when the provisional exercise consumption substantially equals the accumulated exercise amount.

In this instance, even if there is a day(s) that exercise was not performed, the user also performs the exercise of the day and thereby is to be able to enjoy the whole content, in case the content can be executed by the day based on the number of the days from the start date to the target date, and the arithmetic control means executes a part, from the start date to the present time and date, of the content.

### BRIEF DESCRIPTION OF THE DRAWINGS

FIG. 1 is a block diagram of an example in accordance with an embodiment of the present invention;

FIG. 2 is a block diagram showing the operation of the embodiment;

FIG. 3 is an explanatory diagram showing an indication example of the embodiment; and

FIG. 4 is another explanatory diagram showing an indication example of the embodiment.

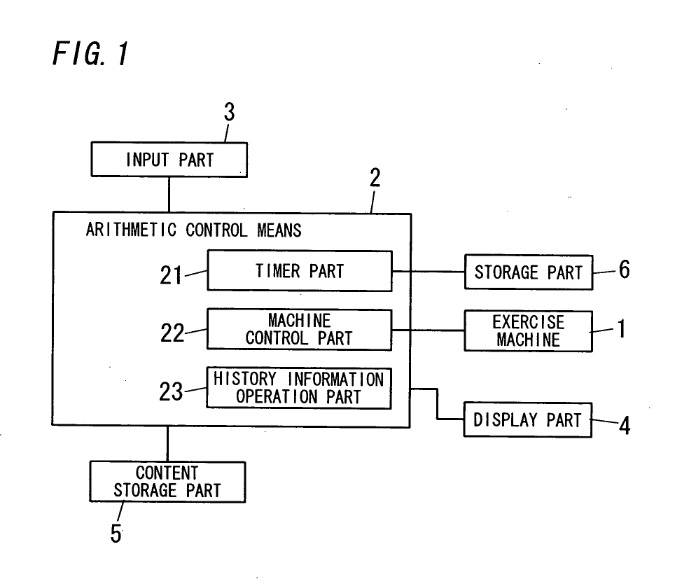

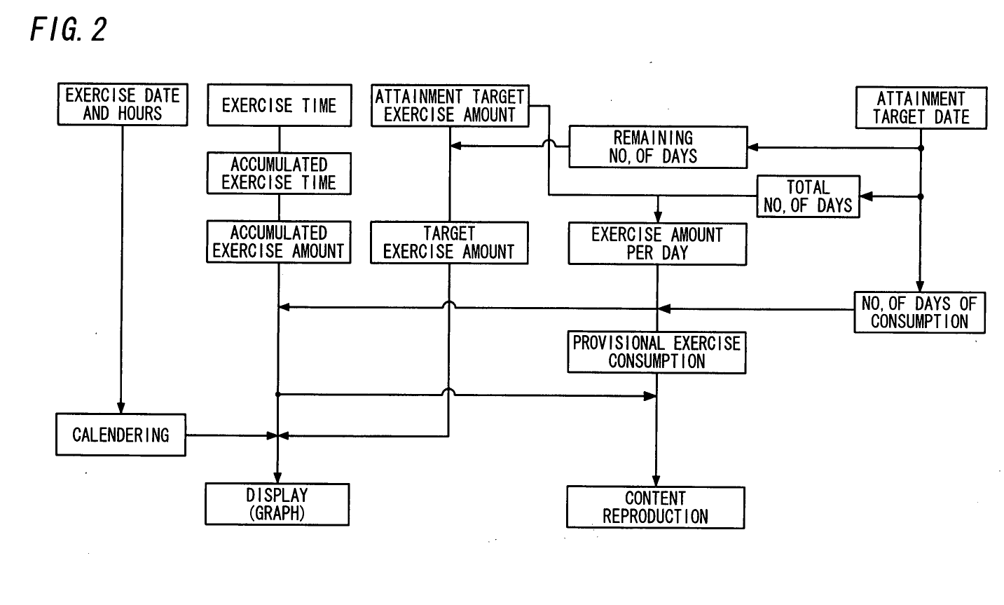

### DESCRIPTION OF THE NUMERALS

1 exercise machine
2 arithmetic control means
3 input part
4 display part
5 content storage part
6 storage part

### BEST MODE FOR CARRYING OUT THE INVENTION

The present invention is explained based on embodiments in the accompanying drawings. The exercise apparatus of the present invention includes, as a main constituent, an exercise machine 1 and an arithmetic control means 2 configured to manage operation control and exercise history information of the exercise machine 1. The exercise machine 1 includes a drive means having a motivity such as a motor or the like, and is configured to add an external force to a user by driving a part of the machine through the drive means. The user is on the part of the machine, or is in contact with the part of the machine. The user exerts a force counteracting the external force, and thereby is to perform exercise. Different exercise machines 1 can be applied to the present invention regardless of their types or functions, and accordingly the concrete construction of the machine is not described herein. However, the aforementioned machine capable of providing exercise simulating horse riding can be employed preferably.

The arithmetic control means 2 is formed of a microcomputer, and includes a timer part 21, a machine control part 22 configured to perform the motion control of the exercise machine 1, and a history information operation part 23. The timer part 21, the machine control part 22 and the history information operation part 23 are provided as functions by software executed by the microcomputer.

The arithmetic control means 2 includes an input interface and an output interface. The input interface is connected with an input part 3 for an input from a user. The output interface is connected with a display part (display) 4 as an indication (report) means for indication with respect to the user. The means 2 is further connected with a content storage part 5 for storing a content set such as novels, video programs and so on, and a storage part 6 for storing a user information set.

The user information set stored in the storage part 6 stores exercise history information and content-relevant information by user's ID. The exercise history information mainly includes information of time and date as well as exercise time, in which exercise was performed each. The content-relevant information represents which content is selected by the user and the content's part which was reproduced.

If a user turns on power of the exercise machine 1, the arithmetic control means 2 displays a question whether the use is new or not, on the display part 4. If the input representing that the user is new is entered through the input part 3, the means 2 puts a question about name to the user. If the user enters the name, the arithmetic control means 2 relates the user's name with ID to store in storage part 6.

If the user activates the exercise machine 1 by switching on the operation switch in the input part 3 and has subsequently performed exercise, the arithmetic control means 2 obtains the operating time of the motivity of the drive means through the timer part 21. Together with time and date, the means 2 stores the operating time as the user's exercise time in the storage part 6. If the user is not new, the arithmetic control means 2 puts a question about the name or ID to check it with the user information set stored in the storage part 6, and adds the exercise time to the corresponding ID data to store it. If exercise is performed, the exercise time is to be recorded.

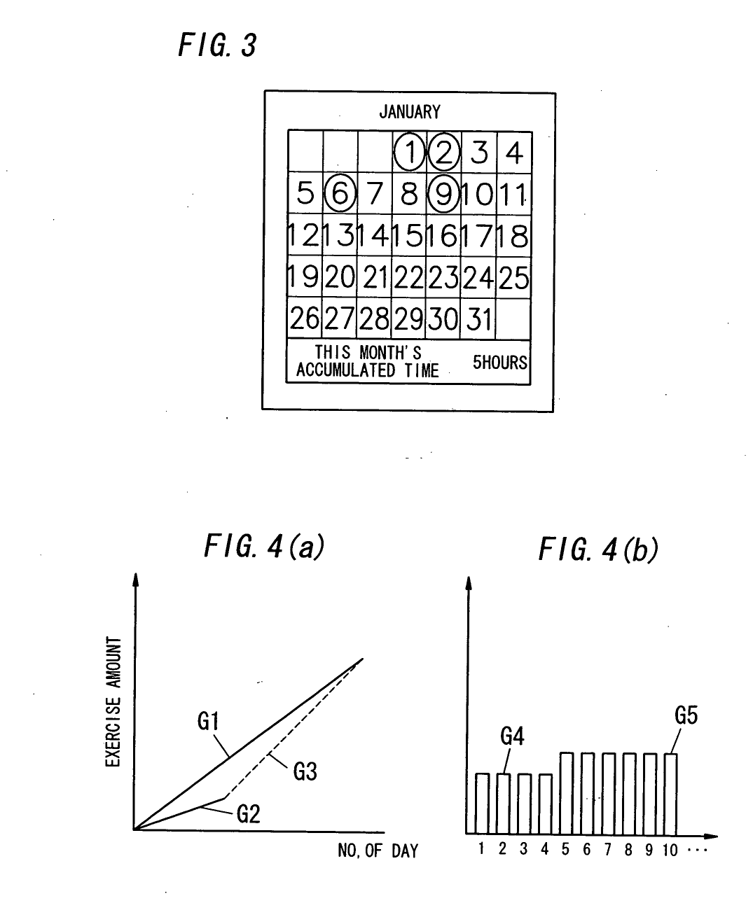

Thus, data of exercise time accumulated by user are processed in the history information operation part 23 as follows, and then is indicated to a user through the display part 4. First, accumulated exercise time is displayed. The accumulated exercise time is an accumulation value of exercise time recorded so far. In this instance, as shown in FIG. 3, if some dates when exercise was performed each are displayed at the same time in a calendar format, a user can understand the information on continuity of exercise at a glance. That is, the user can understand when the user exercised, when the user did not exercise, or the like.

If the user has entered an attainment target exercise amount and a target date to be attained with respect to the target exercise amount, the history information operation part 23 also calculates as follow. That is, based on a predetermined conversion equation between exercise time and exercise amount when exercise is performed by using the exercise machine 1, an accumulated exercise amount is evaluated from the accumulated exercise time, and the difference between the attainment target exercise amount and the accumulated exercise amount (exercise amount difference) is evaluated. A target exercise amount per day is then evaluated by dividing the exercise amount difference by the number of days from the present time and date to the target date (remaining number of days), and is displayed on the display part 4.

The user can understand how much exercise is required every day from now in order to attain the exercise equivalent to the attainment target exercise amount up to the target date. If not only displaying a target exercise amount to be performed every day but also displaying, as shown in FIG. 4(a), the increase G1 and the increase G2 in line chart, the user can have a correct understanding of an increasing tendency of daily exercise amount, where G1 is the increase of exercise amount when exercise is performed every day in accordance with the target exercise amount obtained by dividing the attainment target exercise amount by the number of days from an exercise start date to the target date (total number of days), and G2 is the increase of an accumulated exercise amount of exercise which has been performed so far. The user can also understand an increasing tendency G3 of the exercise amount from now in order to attain the attainment target exercise amount up to the target date.

As shown in FIG. 4(b), if the exercise amount G4 and the exercise amount G5 are displayed in daily bar chart format, the user can easily understand how much is the difference between the exercise amount G4 and the exercise amount G5, where G4 is a daily exercise amount so far, and G5 is a daily exercise amount from now in order to attain the attainment target exercise amount up to the target date.

When a target exercise amount is evaluated so as to surely obtain a daily target exercise amount from now required to attain the attainment target exercise amount up to the target date, the arithmetic control means 2 continuously drives the exercise machine 1 only during the time in which the target exercise amount is obtained through the machine control part 22 on the next exercise with the use of the exercise machine 1. If a user skips a day of exercise, the exercise amount equivalent to the target exercise amount (exercise time) of the day is distributed to each of the coming days, and automatic adjustment is performed so that the total exercise amount becomes the attainment target exercise amount. Thus, if the exercise machine 1 is employed, the exercise of the attainment target exercise amount can be surely performed up to the target date.

The arithmetic control means 2 compares a provisional (virtual) exercise consumption and an accumulated exercise amount so far, where the provisional exercise consumption is obtained by multiplying an exercise amount by the number of days from the exercise start date to present time and date (the number of days of consumption), said exercise amount being obtained by dividing the attainment target exercise amount by the number of days from the exercise start date to the target date. When both are substantially the same, namely a user has been exercising smoothly, after completion of exercise on the day, the means 2 reproduces the content stored in the content storage part 5.

That is, when the attainment target exercise amount is attained on the target date, the whole content can be reproduced. Before that, only a part of the content is reproduced. For example, in case the content is a novel, the content is divided by the day, namely by the number of days from the start date to the target date, and a part from the exercise start date to the present time and date is reproduced. For example, in case each section of the novel is assigned to one day, if a user has been exercising smoothly, the user can read one section each every day. In case the content is video programs of serial drama, if a user has been exercising successfully, the user can watch one story each every day.

Moreover, latter parts of content parts defined by the day cannot be reproduced. For this reason, in order to enjoy the next part of the content, the user needs to further exercise. Accordingly, the user can have the motivation to exercise on the next day, and the continuity of exercise can be enhanced.

As stated above, the user information set includes the content's reproduction information in addition to the exercise history. Accordingly, after exercise of the next date, a user can immediately reproduce the next part of the content part which was read (or watched) at previous time.

Exercise time may be dealt as an exercise amount as is, or a calorie consumption, the number of steps (walking distance) or the like can be used as an exercise amount.

Anyhow, in exercise apparatus, especially passive exercise apparatus, if a user does not have a sense of purpose, continuation is difficult. However, an accumulated exercise amount is indicated to the user, and thereby it is possible to make the user have a recognizable goal for increasing the accumulated exercise amount. Accordingly, the continuity can be enhanced. Especially, an attainment target exercise amount is set and then is compared with an accumulated exercise amount, and thereby the continuity can be more enhanced.

The display part 4 (display) is employed as an indication means with respect a user, but a voice indication means may be used. A means for obtaining user's biological information such as a heart rate or the like may be provided so that the obtained biological information is also stored as a user information set and is indicated to the user as need arises.

1. Exercise apparatus, configured to causing a human body to exercise by adding an external force generated through a drive means to the human body to cause the human body to exert a force counteracting the external force,
wherein the exercise apparatus comprises:
a timer means for measuring the time that the drive means operated, said time being measured as exercise time;
a storage means for storing the measured exercise time together with time and date; and
an arithmetic control means for indicating accumulated exercise time evaluated from the stored exercise time to a user through an indication means.

2. The exercise apparatus of claim 1,
wherein the indication means is a display,
wherein the arithmetic control means is configured to display days, on each of which exercise was performed, in a calendar format on the display.

3. The exercise apparatus of claim 1, comprising an input part for entering a desired attainment target exercise amount and a target date to be attained with respect to the target exercise amount,
wherein the arithmetic control means is configured:
to evaluate a target exercise amount per day by dividing an exercise amount difference by the number of days from the present time and date to the target date, said exercise amount difference being a difference between an accumulated exercise amount obtained from the accumulated exercise time and the attainment target exercise amount; and
to indicate the target exercise amount to the user through the indication means.

4. The exercise apparatus of claim 3, wherein the arithmetic control means is configured to further perform the drive control of the drive means, the arithmetic control means being configured to continuously drive the drive means only during the exercise time that the target exercise amount is obtained.

5. The exercise apparatus of claim 3, comprising a content storage means for storing content,
wherein the arithmetic control means is configured:
to evaluate a provisional exercise consumption by multiplying an exercise amount by the number of days from an exercise start date to the present time and date, said exercise amount being obtained by dividing the attainment target exercise amount by the number of days from the exercise start date to the target date; and
to execute the content when the provisional exercise consumption substantially equals the accumulated exercise amount.

6. The exercise apparatus of claim 5,
wherein the content can be executed by the day based on the number of the days from the start date to the target date,
wherein the arithmetic control means is configured to execute a part of the content, said part being a part from the start date to the present time and date.

7. The exercise apparatus of claim 2, comprising an input part for entering a desired attainment target exercise amount and a target date to be attained with respect to the target exercise amount,
wherein the arithmetic control means is configured:
to evaluate a target exercise amount per day by dividing an exercise amount difference by the number of days from the present time and date to the target date, said exercise amount difference being a difference between an accumulated exercise amount obtained from the accumulated exercise time and the attainment target exercise amount; and
to indicate the target exercise amount to the user through the indication means.

8. The exercise apparatus of claim 7, wherein the arithmetic control means is configured to further perform the drive control of the drive means, the arithmetic control means being configured to continuously drive the drive means only during the exercise time that the target exercise amount is obtained.

9. The exercise apparatus of claim 7, comprising a content storage means for storing content,
wherein the arithmetic control means is configured:
to evaluate a provisional exercise consumption by multiplying an exercise amount by the number of days from an exercise start date to the present time and date, said exercise amount being obtained by dividing the attainment target exercise amount by the number of days from the exercise start date to the target date; and
to execute the content when the provisional exercise consumption substantially equals the accumulated exercise amount.

10. The exercise apparatus of claim 4, comprising a content storage means for storing content,
wherein the arithmetic control means is configured:
to evaluate a provisional exercise consumption by multiplying an exercise amount by the number of days from an exercise start date to the present time and date, said exercise amount being obtained by dividing the attainment target exercise amount by the number of days from the exercise start date to the target date; and
to execute the content when the provisional exercise consumption substantially equals the accumulated exercise amount.

11. The exercise apparatus of claim 8, comprising a content storage means for storing content,
wherein the arithmetic control means is configured:
to evaluate a provisional exercise consumption by multiplying an exercise amount by the number of days from an exercise start date to the present time and date, said exercise amount being obtained by dividing the attainment target exercise amount by the number of days from the exercise start date to the target date; and
to execute the content when the provisional exercise consumption substantially equals the accumulated exercise amount.

12. The exercise apparatus of claim 9,
wherein the content can be executed by the day based on the number of the days from the start date to the target date,
wherein the arithmetic control means is configured to execute a part of the content, said part being a part from the start date to the present time and date.

13. The exercise apparatus of claim 10,
wherein the content can be executed by the day based on the number of the days from the start date to the target date,
wherein the arithmetic control means is configured to execute a part of the content, said part being a part from the start date to the present time and date.

14. The exercise apparatus of claim 11,
wherein the content can be executed by the day based on the number of the days from the start date to the target date,
wherein the arithmetic control means is configured to execute a part of the content, said part being a part from the start date to the present time and date.
